(19) United States
(12) Patent Application Publication
(10) Pub. No.: US 2026/0250945 A1
(43) Pub. Date: Aug. 27, 2026

(54) VACUUM PANEL SYSTEM WITH VARIABLE THERMAL INSULATION FOR SPACE DIVIDER STRUCTURES

(71) Applicant: Pal Tamas Kovacs, Debrecen (HU)

(72) Inventor: Pal Tamas Kovacs, Debrecen (HU)

(21) Appl. No.: 19/270,887

(22) Filed: Jul. 16, 2025

(30) Foreign Application Priority Data
Feb. 26, 2025 (HU) 6070/25

(51) Int. Cl. E04B 1/80; F16L 59/065

(52) U.S. Cl. CPC E04B 1/803; F16L 59/065

(57) ABSTRACT

A vacuum panel system with variable thermal insulation including thermal insulation vacuum panels enclosing an evacuated, sealed interior space is described. A vacuum pump is connected to the thermal insulation vacuum panels arranged in groups by an air pipe. Toggle valves and a three-position valve are fitted into the air pipe to regulate the thermal insulation vacuum panels. A getter tube and a vacuum gauge are connected to the vacuum pump by a toggle valve, and an electronic control unit with operative connections to the vacuum pump, the toggle valves, the three-position valve, the vacuum gauge, an indoor thermometer, and an outdoor thermometer are described.

### TECHNICAL FIELD

The subject of the application is a vacuum panel system with variable thermal insulation for space divider structures, where the pressure conditions in the sandwich structure of the panels can be modified from atmospheric pressure up to the pre-vacuum level (100 kPa-0.1 Pa).

### BACKGROUND

In lightweight-construction building, it is possible to achieve the residential quality for living by using less materials. This contributes to sustainable development as less raw material is used to create a living space of the same or similar quality and level of comfort. For lightweight construction, constantly improving insulation systems are being developed and applied.

The most common insulation method is the use of thick (5-12 cm) polystyrene panels, where the surfaces of statically stable wall structures are covered with insulating polystyrene sheets. Although expanded polystyrene is not considered hazardous waste, the demolition of wall structures generates a significant volume of waste that is difficult to recycle. Such a thermal insulation system for buildings is described in the patent document with publication No. HU P1300433 A, consisting of conjoined conventional Styrofoam thermal insulation panels with air ducts and a temperature and humidity control air circulation unit connected to the air ducts by piping. Cover elements are affixed to the exterior-facing side of the thermal insulation panels. In this solution, temperature and humidity are controlled by a separate air circulation system independent of the 6-12 cm thick thermal insulation panels.

Increasingly common insulation techniques include the use of closed-cell polyurethane (PUR) foam. In addition to the wide range of construction applications, rigid polyurethane foam products can be found in other industries as well, from insulating refrigerators to filling car dashboards. It is estimated that millions of tonnes of polyurethane are incorporated into industrial products every year. At the current state of the art, the recycling of rigid polyurethanes is unresolved, and there is only a limited potential for the recycling of foams, under specific conditions.

The state-of-the-art sandwich-structured vacuum panels have been developed by utilising the good thermal insulation capacity of vacuum space.

In the patent document with publication No HU P1300433 A, a thermal insulation vacuum panel comprising a three-layer cardboard casing with a thickness of 1.5-3 cm and a perforated paper grid spacer arranged in the interior space of the casing is proposed. A disadvantage of this solution is that the thermal insulation of the panel cannot be modified, and its structure is not sufficiently load-bearing and cannot be used for buildings.

In the patent document with publication No EP 2522505 A2, a thermal insulation vacuum panel is disclosed. The core part of the panel consists of glass fibre sheets bonded together, with a vacuum of 0.1-10 Pa in the interior space. A container containing quicklime powder is placed in the core. The outer casing of the panel is a laminated structure consisting of a protective layer, a metal layer and an adhesive layer. A disadvantage of this solution is that the thermal insulation of the panel cannot be modified by changing the vacuum level.

In the patent document with publication No CN 110984465 A, a vacuum panel consisting of two glass sheets is described. The glass sheets are connected to each other at their edges by a T-shaped insulating gasket, hermetically sealing the interior space of the panel under vacuum.

Spacers are arranged between the glass sheets, in the interior space of the panel, to provide the stability of the structure under vacuum. A vacuum valve is installed into one of the glass sheets and can be connected to a vacuum pump to create a vacuum in the interior space of the panel. In the document, no solution is recommended for modifying the thermal insulation of the product.

A common feature of the known processes of thermal insulation is that the insulation performance of the insulation is not variable once it has been formed. The quality of the insulation degrades in the long term, its initial capacity deteriorates over time. Adjustable thermal insulation of building walls has not been developed in everyday practice. However, during the spring and autumn seasons, weather conditions often arise where a wall with variable thermal insulation could significantly reduce heating costs and the amount of energy needed to achieve the right indoor temperature. The problem is that warmer or colder outside temperatures on walls with fixed thermal insulation can only heat or cool the indoor air with poor efficiency. It is a natural expectation that the building walls should be well insulated at dawn and in the evening, that cold air should not cool the indoor air, but also that during the day the rapidly warming outdoor air should not heat the indoor air. In the latter case, by reducing the insulation performance of the wall with variable thermal insulation, it would be possible to achieve a more efficient heat transfer between the outdoor and indoor air, without turning on the heating units. Variable capacity thermal insulation is also effective on hot summer days when the cool air at dawn could cool the indoor air. It can be seen that the use of space divider structures with variable thermal insulation capacity would support the energy efficient operation of the heating/cooling system, for which there is a real demand.

### SUMMARY OF THE INVENTION

In view of the deficiency of known thermal insulation methods and the demand for modernisation, we consider it our task to provide a space divider system built of vacuum panels, where the thermal insulation capacity of the vacuum panels can be modified according to the seasons and times of day, as well as the weather conditions, in accordance with the temperature requirements set by the user. The system should enable the insulation performance of vacuum panels at the time of installation to be maintained under active intervention, controlled by continuously monitored indicator parameters.

A further task is to ensure that the variable capacity thermal insulation system does not require vacuum panels with a thick, robust construction, but rather consists of thin sandwich-structured panels with a minimum thermal insulation capacity of 0.005 W/mK at the maximum vacuum level.

Another additional task is to make the vacuum panels suitable for building the wall structure of lightweight-construction buildings, but also for the subsequent wall insulation of existing building structures.

In the course of the experiments carried out to accomplish the tasks defined, we realised that an extensive space divider system of variable thermal insulation capacity consisting of several vacuum panels can be served safely by a single vacuum pump, if a system of adjustable vacuum panel groups is developed and the groups are connected to the vacuum pump.

Our formulated tasks are realised using a vacuum panel system with variable thermal insulation, consisting of thermal insulation vacuum panels enclosing an evacuated, sealed interior space, arranged in groups. The vacuum panels are polygonal elements with straight edges and flat surfaces, where the hermetically sealed, so-called warm-edge profile elements forming a closed frame at the edges join the parallel panel sheets forming the vacuum panels together. The profile elements are bonded between the panel sheets using butyl adhesive, where the butyl provides the primary sealing and bonding. A secondary sealant and adhesive polyurethane layer is applied to the edges of the vacuum panels to provide durable air-tightness to the vacuum panel, as well as mechanical protection.

One panel sheet of the vacuum panels is fitted with a pipe end which is connected by an air pipe to the vacuum pump that draws air from the interior space of the vacuum panels. The interior space of the vacuum panels is fitted with a spacer, which is a thin, flat tray with holes and balls inserted into circular cavities. The purpose of the spacer is to ensure the parallelism of the panel sheets during the service life of the vacuum panel, and to reinforce the vacuum panel under variable vacuum load. The tray positions the balls in contact with the panel sheets in an evenly distributed manner. The balls can be made of glass, Teflon or hard plastic. The small holes in the tray serve to equalise the pressure in the space above and below the tray, ensuring that the vacuum in the interior space of the vacuum panel, when it has been vacuumed off, does not pull the tray against one of the panel sheets.

Vacuum panels are 10 to 40 mm thick structural elements, and the panel sheets are steel or aluminium plates with a thickness of 1 to 3 mm. Their shape is preferably triangular or rectangular.

The vacuum panel groups are connected to the vacuum pump by air pipes. The air pipe is fitted with toggle valves (on-off valves) controlling the vacuum panel groups and a three-position valve connected to a getter tube and a vacuum gauge.

The getter tube is used to bind the moisture content of the air entering the system during the ventilation of the system, and a toggle valve is connected to its inlet side. The getter tube has a cylindrical container containing a dehumidifying filling, preferably silica gel filling. The two ends of the container are sealed by threaded caps with pipe ends, allowing access to the filling and the airtight closure of the getter tube.

The system has an electronic control unit with wired connections to the vacuum pump, the toggle valves, the three-position valve, the vacuum gauge, an indoor thermometer and an outdoor thermometer. The control unit uses a unique algorithm to control the operation of the system, opening or closing the toggle and three-position valves. Control is based on the temperature data from the outdoor and indoor thermometers and the measured vacuum value.

The objectives formulated can be achieved by means of the vacuum panel system with variable thermal insulation described in claim 1, the preferred embodiments of which are described in the sub-claims.

### DESCRIPTION OF DRAWINGS

In order to better describe and illustrate embodiments or examples of the applications disclosed herein, reference may be made to one or more drawings. Additional details or examples used to describe the drawings should not be construed as limiting the scope of any one of the disclosed applications, the presently described embodiments or examples, and the best modes presently understood for these applications.

FIG. 1 illustrates the vacuum panel design,

FIG. 2 shows the variation of the pressure on the panel sheets,

FIG. 3 shows the design of the pipe end fitted into the vacuum panel,

FIG. 4 is a drawing of the getter tube,

FIG. 5 is a drawing of the spacer,

FIG. 6 shows the design of the vacuum panel system with variable thermal insulation, and

FIG. 7 shows the layout of the control system.

### List of Reference Codes

1—vacuum panel
2—panel sheet
3—profile element
4—butyl adhesive
5—polyurethane layer
6—(evacuated, sealed) interior space
7—pipe end
7.1—flange
7.2—groove
8—spacer
8.1—tray
8.2—cavity
8.3—hole
8.4—ball
9—thread
10—nut
11—washer
12—O-ring
13—getter tube
13.1—container
13.2—cap
13.3—insert
13.4—pipe end
13.5—silica gel
14—vacuum pump
15—vacuum gauge
16.1-16.5—toggle valve
17—three-position valve
18—air pipe
19—control unit
20—indoor thermometer
21—outdoor thermometer

### DETAILED DESCRIPTION

Aspects of the invention include but are not limited to:

1) A vacuum panel system with variable thermal insulation comprising thermal insulation vacuum panels enclosing an evacuated, sealed interior space, comprising:
a vacuum pump connected to the thermal insulation vacuum panels arranged in groups by an air pipe),
toggle valves and a three-position valve fitted into the air pipe to regulate the thermal insulation vacuum panels,
a getter tube and a vacuum gauge connected to the vacuum pump by a toggle valve, and
an electronic control unit with operative connections to the vacuum pump, the toggle valves, the three-position valve, the vacuum gauge, an indoor thermometer, and an outdoor thermometer.

2) A vacuum panel system with variable thermal insulation according to aspect 1, wherein each of the thermal insulation vacuum panels are polygonal elements with straight edges and a flat surface, on which hermetically sealed profile elements forming a closed frame at the edges join the parallel panel sheets forming the vacuum panels together.

3) A vacuum panel system with variable thermal insulation according to any of the preceding aspects, wherein the vacuum panel has a thickness of 10 to 40 mm.

4) A vacuum panel system with variable thermal insulation according to any of the preceding aspects in any combination, wherein the panel sheets are steel or aluminium plates and each panel sheet has a thickness of 1 to 3 mm.

5) A vacuum panel system with variable thermal insulation according to any of the preceding aspects in any combination, wherein the profile elements are bonded to the panel sheets with butyl adhesive.

6) A vacuum panel system with variable thermal insulation according to any of the preceding aspects in any combination, wherein a polyurethane layer is applied to the edges of the vacuum panels.

7) A vacuum panel system with variable thermal insulation according to any of the preceding aspects in any combination, wherein one panel sheet of the vacuum panels is fitted with a pipe end.

8) A vacuum panel system with variable thermal insulation according to any of the preceding aspects, wherein the interior space of the vacuum panels is fitted with a spacer.

9) A vacuum panel system with variable thermal insulation according to any of the preceding aspects, wherein the spacer is a flat tray with holes, in which balls are inserted into circular cavities.

10) A vacuum panel system with variable thermal insulation according to any of the preceding aspects, wherein the balls are made of glass, Teflon or hard plastic.

11) A vacuum panel system with variable thermal insulation according to any of the preceding aspects, wherein the getter tube has a cylindrical container, both ends of which are closed by threaded caps fitted with a pipe end.

12) A vacuum panel system with variable thermal insulation according to any of the preceding aspects, wherein the container of the getter tube contains a dehumidifying filling.

13) A vacuum panel system with variable thermal insulation according to any of the preceding aspects, wherein the dehumidifying filling is silica gel.

The vacuum panel 1 shown in FIG. 1 is a polygonal structural element with straight edges and flat surfaces, consisting of two parallel panel sheets 2 and so-called warm-edge profile elements 3 connecting the panel sheets 2 at the edges of the vacuum panel 1. The profile elements 3 are affixed at the edges with butyl adhesive 4 between the panel sheets 2, thus forming the vacuum panel 1 with a closed frame structure, enclosing the hermetically sealed, evacuated hollow interior space 6. The edges of the vacuum panel 1 are coated with an additional sealing and adhesive polyurethane layer 5, which ensures the durable air-tightness of the vacuum panel 1, but also provides mechanical protection to the structural element.

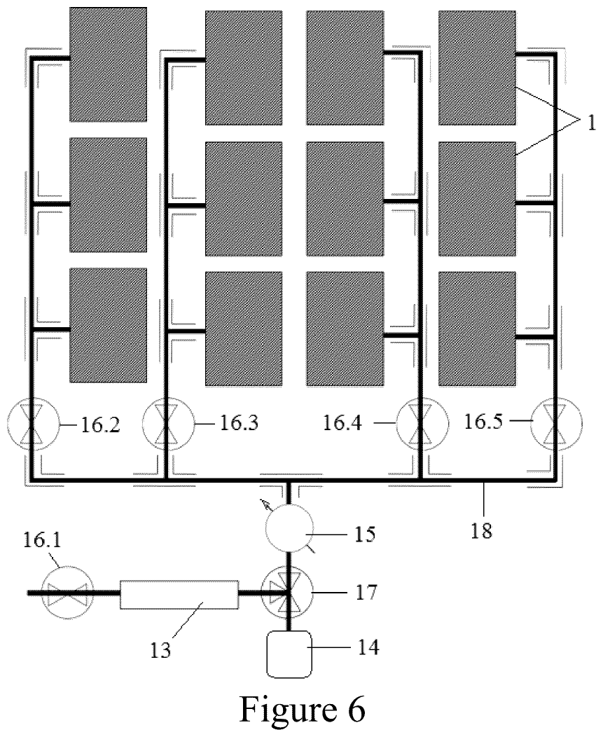

One panel sheet of the vacuum panel 1 is fitted with a pipe end 7, which is connected by an air pipe 18 to the vacuum pump 14 drawing air from the interior space 6 of the vacuum panel 1 (see FIG. 6).

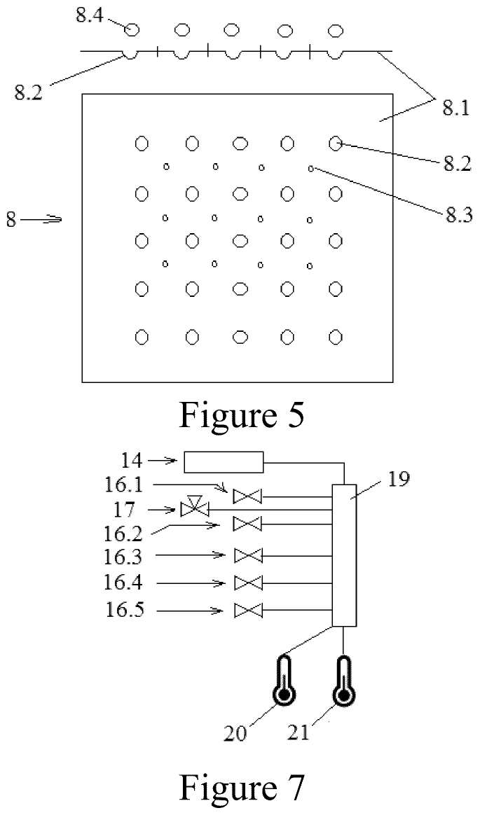

The interior space 6 of the vacuum panel 1 is fitted with a spacer 8 (see FIG. 5), the purpose of which is to ensure the parallelism of the panel plates 2, and to reinforce the vacuum panel 1 under variable vacuum load.

The vacuum panel 1 is 10 to 40 mm thick, and the panel sheets 2 are steel or aluminium plates with a thickness of 1 to 3 mm. The shape of the vacuum panel 1 is preferably triangular or rectangular, and no guideline value can be provided for the dimensions—the length and width—of its surface, as these depend on the building structure.

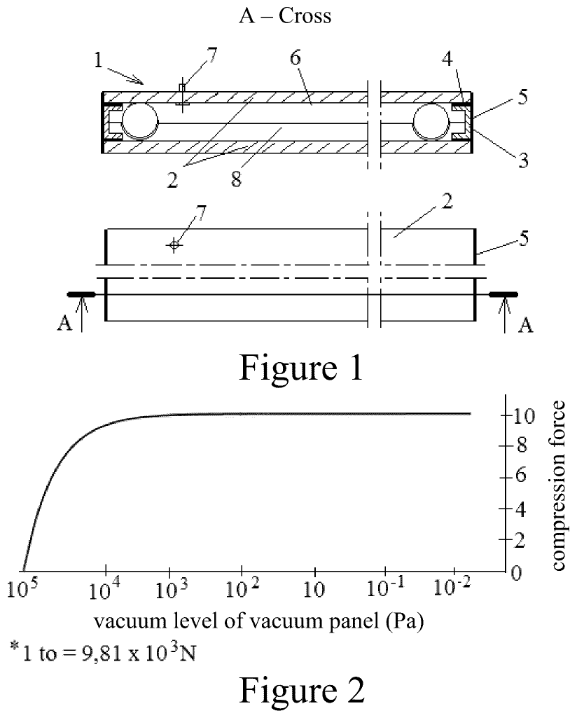

FIG. 2 illustrates the variation of the pressure on the panel sheets. The figure shows that the vacuum-induced compression force increases gradually as the pressure in the interior space 6 of the vacuum panel 1 decreases, and at the 10-mbar order of magnitude it reaches a value of 10 tonnes mass equivalent. It is therefore essential to maintain the static stability of the panel sheets 2 permanently, which requires the use of a spacer 8 of a material with sufficient strength and poor thermal conductivity (good thermal insulation).

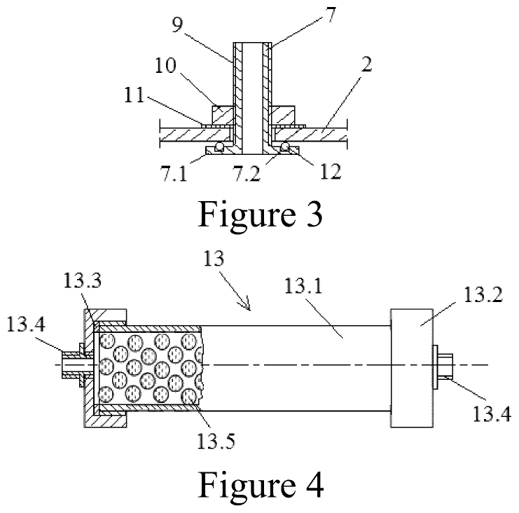

FIG. 3 illustrates the design of the pipe end 7 to be fitted into the vacuum panel 1, to which the air pipe 18 can be connected by means of a union nut, connecting the vacuum pump 14 to the vacuum panel 1 (see FIG. 6). The pipe end 7 has a thread 9 with a size matching the union nut, and one end has a flange 7.1 with a circular groove 7.2. The pipe end 7 should be pushed out of the interior space 6 of the vacuum panel 1 through the hole cut into the panel sheet 2, and fixed to the outer surface of the panel sheet 2 using the washer 11 and the nut 10, while the O-ring 12, which is inserted into the groove 7.2 of the flange 7.1 and is pressed against the panel sheet 2 in the interior space 6, reliably seals the pipe end 7.

The getter tube 13 shown in FIG. 4 is used to bind the moisture content of the air let into the vacuum panel 1 during the ventilation of the system. In order to lessen the thermal insulation capacity of the system (see FIG. 6) and thus reduce the vacuum in the vacuum panel 1, the vacuum panel 1 must be refilled with air, which is done by means of the getter tube 13. The getter tube 13 is a cylindrical container containing a dehumidifying filling, preferably silica gel filling 13.5. The two ends of the container 13.1 are sealed by threaded caps 13.2 fitted with pipe ends 13.4 and washers 13.3, allowing access to the dehumidifying filling if required.

The spacer 8 shown in FIG. 5 is a thin, flat plastic tray 8.1 with small holes 8.3 and circular cavities 8.2. In the cavities 8.2, balls 8.4 of a material with sufficient strength and poor thermal conductivity (good thermal insulation), e.g. glass, Teflon or rigid plastic, are arranged. The balls 8.4 in contact with the panel sheets 2 are arranged evenly distributed, 8 to 10 cm apart on the tray 8.1, and sized to fit the internal space 6 of the vacuum panel. The small holes 8.3 cut into tray 8.1 allow the pressure in the space above and below tray 8.1 to be equalised, preventing the vacuum in the interior space 6 of the vacuum panel 1, when vacuumed off, from pulling the tray 8.1 against one of the panel sheets 2.

FIG. 6 is a layout drawing of the vacuum panel system with variable thermal insulation. In the system, the vacuum panels 1 are arranged parallel to each other, in groups. In each group, one of each of the toggle valves 16.2 to 16.5 is installed into its air pipe 18, to open or close the air pipe 18 of the group, and they are connected collectively to the vacuum pump 14 through a vacuum gauge 15 and a three-position valve 17. One branch of the three-position valve 17 is connected to the getter tube 13, and using the toggle valve 16.1 fitted on the inlet side of it, and being in contact with the open airspace, the ventilation function of the getter tube 13 can be started or locked out.

FIG. 7 is a schematic drawing of the system control. The system has an electronic control unit 19 connected to the vacuum pump 14, the toggle valves 16.1 to 16.5, the three-position valve 17, the vacuum gauge 15, and an indoor thermometer 20 and an outdoor thermometer 21. The control unit 19 uses a unique algorithm to control the operation of the system.

The control unit 19 is an Arduino panel, an open-source electronic microcontroller that can be programmed using Arduino IDE software, which is downloadable from a computer.

The signals from the thermometers 20, 21 located in the interior and exterior of the building where the system is operated, as well as the signal of the vacuum gauge 15 measuring the vacuum level of the combined groups of vacuum panels 1, are transmitted to the control unit 19, which controls the operation of the vacuum pump 14, i.e. switches it on and off at the set temperature and pressure parameters. The vacuum levels of the parallel branches of vacuum panels 1 can be individually controlled by means of the controllable toggle valves 16.1 to 16.5 and the three-position valve 17. In this way, the thermal insulation of the sandwich-structured vacuum panel walls can be controlled according to the time of day and the season.

The control functions are:
1. Suction of the entire vacuum system
2. Vacuum suction per group of vacuum panels 1
3. Static state, checking of vacuum levels
4. Ventilation per group of vacuum panels 1
5. System ventilation
6. Regeneration of the getter filling

### 1) Suction of the Entire Vacuum System

When the entire vacuum system is suctioned, the toggle valve 16.1 and the branch of the three-position valve 17 on the side of the getter tube 13 are closed, the other toggle valves 16.2 to 16.5 are open. The vacuum pump 14 is in operation and the vacuum level is measured and checked by the vacuum gauge 15. When a predefined vacuum level is reached, the control system closes the toggle valves 16.2 to 16.5 and switches off the vacuum pump 14.

### 2) Vacuum Suction Per Group of Vacuum Panels 1

For example, in FIG. 6, if intervention is required in the first group of vacuum panels 1 on the left, the toggle valve 16.1, the branch of the three-position valve 17 on the side of the getter tube 13, and the toggle valves 16.3 to 16.5 are closed and the toggle valve 16.2 is open. The vacuum pump 14 is in operation and the vacuum level is measured and checked by the vacuum gauge 15. When a predefined vacuum level is reached, the control system closes the toggle valve 16.1 and switches off the vacuum pump 14.

### 3) Static State; Checking of Vacuum Levels

In the static state, when the toggle valves 16.1 to 16.5 and the three-position valve 17 are closed and the vacuum pump 14 is not in operation, the vacuum levels shall be checked per group of vacuum panels 1. In FIG. 6, when checking the first group of vacuum panels 1 on the left, all valves except the toggle valve 16.2 are closed. At this time, the vacuum gauge 15 measures the vacuum level of the first group of vacuum panels 1. If the measured value is within the set limit, the control system moves on to check the next branch, closing the toggle valve 16.2 and opening the toggle valve 16.3. All groups of vacuum panels 1 shall be checked in this order. If the measured vacuum level is outside the limit, vacuum suction shall be performed in the group of vacuum panels 1. The entire system is checked in cycles of approximately half an hour.

### 4) Ventilation Per Group of Vacuum Panels 1

When the temperature indicators show that it is worth ventilating one of the groups of vacuum panels 1, e.g. the first group on the left in FIG. 6, the control system opens the toggle valve 16.2 belonging to that group and the toggle valves 16.3 to 16.5 are closed. The vacuum pump 14 is not in operation, the branch of the three-position valve 17 on the side of the vacuum pump 14 is closed, and the toggle valve 16.1 belonging to the getter tube 13 is open. The pressure difference causes the outside humid air to flow into the getter tube 13, and the getter filling binds the moisture content of the air. The dehumidified air flows into the system, increasing the pressure of the first group of vacuum panels 1 on the left. At the end of the ventilation process, the toggle valves 16.1 and 16.2 close.

### 5) System Ventilation

Carried out in accordance with section 4. The branch of the toggle valve 16.2 on the side of the vacuum pump 14, the valve 16.1 and the toggle valves 16.3 to 16.5 are open, and the vacuum pump 14 is not in operation. The pressure difference causes the outside humid air to flow into the getter tube 13, and the getter filling binds the moisture content of the air. The dehumidified air flows back into the system, increasing the pressure of the groups of vacuum panels 1 on the left.

### 6) Regeneration of the Getter Filling

If regeneration of the getter filling in the getter tube 13 is possible by vacuum suction, the control system shall proceed as follows. The branch of the three-position valve 17 on the side of the vacuum panels 1 and the toggle valve 16.1 are closed, and the vacuum pump 14 is in operation. Due to the evacuated space, the water vapour bound in the getter filling starts to evaporate, and it is suctioned by the vacuum pump 14 and discharged into the environment through its exhaust.

Considering the above, it can be seen that the invention fulfils the tasks formulated. The design of the system allows the thermal insulation capacity of the vacuum panels to be modified according to the seasons and times of day, as well as the weather conditions, in accordance with the temperature requirements set by the user. The vacuum panels are thin but rigid sandwich-structured structural elements that can be used for the construction of space divider structures and for the subsequent wall insulation of existing building structures. In the first case, vacuum panels are incorporated into a so-called curtain wall bearing structure. In the second case, a simplified version of the curtain wall bearing structure is affixed to the existing wall structure by drilling. In addition, liner wood can be affixed to the panel sheets of the vacuum panels facing the interior of the building, and the wall covering can be installed on it to ensure a uniform interior appearance. In the air gap provided by the liner wood, fittings and connectors can be concealed.

What is claimed is:

1. A vacuum panel system with variable thermal insulation comprising thermal insulation vacuum panels enclosing an evacuated, sealed interior space, comprising:
a vacuum pump connected to the thermal insulation vacuum panels arranged in groups by an air pipe),
toggle valves and a three-position valve fitted into the air pipe to regulate the thermal insulation vacuum panels,
a getter tube and a vacuum gauge connected to the vacuum pump by a toggle valve, and
an electronic control unit with operative connections to the vacuum pump, the toggle valves, the three-position valve, the vacuum gauge, an indoor thermometer, and an outdoor thermometer.

2. The vacuum panel system with variable thermal insulation according to claim 1, wherein each of the thermal insulation vacuum panels are polygonal elements with straight edges and a flat surface, on which hermetically sealed profile elements forming a closed frame at the edges join the parallel panel sheets forming the vacuum panels together.

3. The vacuum panel system with variable thermal insulation according to claim 2, wherein the vacuum panel has a thickness of 10 to 40 mm.

4. The vacuum panel system with variable thermal insulation according to claim 2 in any combination, wherein the panel sheets are steel or aluminium plates and each panel sheet has a thickness of 1 to 3 mm.

5. The vacuum panel system with variable thermal insulation according to claim 2 in any combination, wherein the profile elements are bonded to the panel sheets with butyl adhesive.

6. The vacuum panel system with variable thermal insulation according claim 2 in any combination, wherein a polyurethane layer is applied to the edges of the vacuum panels.

7. The vacuum panel system with variable thermal insulation according to claim 2 in any combination, wherein one panel sheet of the vacuum panels is fitted with a pipe end.

8. The vacuum panel system with variable thermal insulation according to claim 1, wherein the interior space of the vacuum panels is fitted with a spacer.

9. The vacuum panel system with variable thermal insulation according to claim 8, wherein the spacer is a flat tray with holes, in which balls are inserted into circular cavities.

10. The vacuum panel system with variable thermal insulation according to claim 9, wherein the balls are made of glass, Teflon or hard plastic.

11. The vacuum panel system with variable thermal insulation according to claim 1, wherein the getter tube has a cylindrical container, both ends of which are closed by threaded caps fitted with a pipe end.

12. The vacuum panel system with variable thermal insulation according to claim 11, wherein the container of the getter tube contains a dehumidifying filling.

13. The vacuum panel system with variable thermal insulation according to claim 12, wherein the dehumidifying filling is silica gel.
